(19) United States
(12) Patent Application Publication
(10) Pub. No.: US 2014/0295314 A1
(43) Pub. Date: Oct. 2, 2014

(54) MICROPOROUS LAYER FOR A FUEL CELL WITH ENHANCED ICE STORAGE

(71) Applicant: Ford Global Technologies, LLC, Dearborn, MI (US)

(72) Inventors: Zijie LU, Novi, MI (US); James WALDECKER, Plymouth, MI (US); Michael Allen DEBOLT, Saline, MI (US)

(73) Assignee: Ford Global Technologies, LLC, Dearborn, MI (US)

(21) Appl. No.: 14/271,705

(22) Filed: May 7, 2014

Related U.S. Application Data
(63) Continuation-in-part of application No. 13/832,943, filed on Mar. 15, 2013.
Application No. 13/832,943 is a continuation-in-part of application No. 13/832,358, filed on Mar. 15, 2013.

(51) Int. Cl. H01M 8/04

(52) U.S. Cl. CPC H01M 8/04291
USPC 429/480

(57) ABSTRACT

A fuel cell includes a cathode having a first gas diffusion layer and a first catalyst layer, an anode including a second gas diffusion layer and a second catalyst layer and a proton exchange membrane disposed between the cathode and anode. A microporous layer is disposed between the first gas diffusion layer and the first catalyst layer. The microporous layer defines a plurality of domains extending between opposite surfaces of the microporous layer. Under freezing conditions the microporous layer is arranged to concentrate ice formation within the domains to reduce an amount of frozen water within the catalyst layer.

### CROSS-REFERENCE TO RELATED APPLICATIONS

This application is a continuation-in-part of application Ser. No. 13/832,943, filed Mar. 15, 2013, and a continuation-in-part of application Ser. No. 13/832,358, filed Mar. 15, 2013, the disclosures of which are hereby incorporated in their entirety by reference herein.

### TECHNICAL FIELD

This disclosure relates to microporous layer structures for use in proton exchange membrane fuel cell systems.

### BACKGROUND

Concerns about environmental pollution and fossil fuel depletion have led to urgent demand for alternative clean energy solutions. The hydrogen fuel cell, for example, the proton exchange membrane fuel cell (PEMFC), is one potential energy conversion system for future automobiles and stationary applications. The reaction in a PEMFC involves hydrogen molecules splitting into hydrogen ions and electrons at the anode, while protons re-combine with oxygen and electrons to form water and release heat at the cathode. A fuel cell can be very complicated and delicate due to the specific requirements of high power output (fast reaction and dynamics), longevity, and economical effectiveness. Generally, a proton exchange membrane is used as a proton conductor in a PEMFC. A catalyst layer containing, for example, platinum and/or platinum alloy is used to catalyze the electrode reactions. A gas diffusion layer, which may include a microporous layer and a carbon fiber based gas diffusion backing layer, is used to transport reactant gases and electrons as well as remove product water and heat. In addition, a flow field plate is generally used to distribute the reactant gas.

### SUMMARY

In one embodiment a fuel cell comprises a cathode having a first gas diffusion layer and a first catalyst layer, an anode including a second gas diffusion layer and a second catalyst layer and a proton exchange membrane disposed between the cathode and anode. A microporous layer is disposed between the first gas diffusion layer and the first catalyst layer. The microporous layer defines a plurality of bores extending between opposite surfaces of the microporous layer. Under freezing conditions the microporous layer is arranged to concentrate ice formation within the bores to reduce an amount of frozen water within the catalyst layer.

In another embodiment, a fuel cell microporous layer is disposed between a catalyst layer and a gas diffusion backing layer on a cathode side of the fuel cell. The microporous layer comprises a bulk material. The bulk material defines a plurality of pores and a plurality of domains. Under freezing conditions the domains are configured to concentrate ice formation within the domains to reduce an amount of frozen interface between the bulk material and the catalyst layer.

In yet another embodiment, a cathode microporous layer for a fuel cell comprises a first carbon-based material layer adjacent to the catalyst layer and a second carbon-based material layer disposed between the first layer and a gas diffusion backing layer. The second carbon-based material includes a plurality of domains that are configured to concentrate ice formation, under freezing conditions, within the domains to reduce an amount of frozen water within the catalyst layer.

### BRIEF DESCRIPTION OF THE DRAWINGS

FIG. 1 illustrates a schematic drawing of a proton exchange membrane fuel cell.

FIG. 2 illustrates a cross-section of a prior art proton exchange membrane fuel cell operating under freezing conditions.

FIG. 3 illustrates a plan view of a microporous layer according to one embodiment.

FIG. 4 illustrates a cross-section view of the microporous layer shown in FIG. 3.

FIGS. 5A to 5C illustrate a process for fabricating a microporous layer according to one embodiment.

FIG. 6 illustrates a cross-section view of a proton exchange membrane fuel cell of one embodiment operating under freezing conditions.

FIG. 7 illustrates a cross-section view of a microporous layer according to another embodiment.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Although PEMFC technology has undergone significant development over the past decade, a PEMFC with high performance and increased robustness at a low cost has yet to be achieved. Therefore, fuel cells are yet to be significantly commercialized. One of the important technical challenges of PEMFCs is water management. This is mainly dictated by the current polymer electrolyte membrane, which exhibits high proton conductivity only in the well hydrated state. The hydration requirement of the electrolyte limits the maximum fuel cell operating temperature to about 90° Celsius (C). Above this temperature, membrane dry-out may occur, resulting in decreased proton conductivity. On the other hand, if the product water is not removed efficiently, it may cause water accumulation and flood the electrodes. This causes mass transport loss and may even stop fuel cell operation.

Liquid water accumulation in various fuel cell components makes two-phase flow (e.g., liquid and gas) almost unavoidable for PEMFC operation, especially at low temperatures and high current densities. The accumulated liquid water solidifies to form ice at sub-freezing temperatures. The capability to efficiently handle liquid water flow and ice formation is an important criterion when designing and selecting PEMFC components and operating conditions. According to Faraday's law, water generation at the cathode catalyst layer as a result of the reduction reaction can be determined by the following equation:

J_{H2O}=Mj/2Fρ (1)

where
J_{H2O} is the water flux in cm³/(s·cm²);
M is the molecular weight of water (i.e., 18 grams/mole);
j is the operating current density in A/cm²;
F is the Faraday constant (i.e., approx. 96,485 C/mol); and
ρ is the density of liquid water (i.e., 1 g/cm³ at 25° C.).

In order to achieve a suitable balance between the hydration requirements of various fuel cell components and the rejection of excess water from the fuel cell system, the design of the fuel cell can be tailored to effectively manage water under the given operating conditions of the system. A PEMFC includes a number of components that can potentially employ particular material and structural designs in order to enhance water management within the assembly. As disclosed herein, the particular gas diffusion layer of a PEMFC, typically including a carbon fiber based gas diffusion backing layer and a microporous layer disposed at the interface between the gas diffusion backing layer and an adjacent catalyst layer, performs an integral role in the management of water throughout both the electrode assembly and the larger fuel cell system. Based on the characteristics and operating conditions of a given PEMFC, the architecture of the gas diffusion layer assembly, including the structure and design of the microporous layer, can be optimized in order to enhance the management of water throughout the fuel cell system.

In vehicle applications, operating in sub-freezing temperature conditions may be common, especially in colder climates. Therefore, it is important to provide a fuel cell that is operational at sub-freezing temperatures. At sub-freezing temperatures the liquid water in the fuel cell may solidify to ice. The ice may form a frozen interface at the catalyst layer-gas diffusion layer boundary and block oxygen molecules from diffusing into the catalyst layer. The ice may also block liquid water for diffusing out of the catalyst layer to be carried away by the gas streams. This retards the electrochemical reaction, which can cause failed startup and accelerated catalyst and material degradation.

With reference to FIG. 1, an example of a PEMFC 10 is illustrated. The PEMFC 10 generally includes a negative electrode (anode) 12 and a positive electrode (cathode) 14, separated by a proton exchange membrane (PEM) 16 (also a polymer electrolyte membrane). The anode 12 and the cathode 14 may each include a gas diffusion layer (GDL) 19, a catalyst layer 20, and a flow field plate 22 which forms a gas channel 24. The GDL 19 may be the same for the anode 12 and the cathode 14. Alternatively, the anode 14 may have a GDL 19′ and the cathode 14 may have a different GDL 19″. In at least one embodiment, the anode GDL 19′ is thicker than the cathode GDL 19″ due to reduced gas diffusion requirements of the anode 12 compared to the cathode 14. The catalyst layer 20 may be the same for the anode 12 and the cathode 14, but generally the anode 12 will have a catalyst layer 20′ and the cathode 14 will have a different catalyst layer 20″. The catalyst layer 20′ may facilitate the splitting of hydrogen atoms into hydrogen ions and electrons while the cathode 14 facilitates the reaction of oxygen gas and electrons to form water. The GDL 19 includes a gas diffusion backing layer (GDBL) 18 and a microporous layer (MPL) 26.

Conventional GDBL 18 materials for PEMFCs are carbon fiber based paper and cloth with a thickness of about 200 microns. These materials are highly porous (having porosities of about 80%) to allow reactant gas transport to the catalyst layer (which generally has a thickness of about 10-15 microns), as well as water transport from the catalyst layer. In order to facilitate the removal of water, GDLs are typically treated to be hydrophobic with a non-wetting polymer such as polytetrafluoroethylene (PTFE), commonly known by the trade name Teflon. Conventional GDLs have a primary pore size in the range of 1 to hundreds of microns. Water produced in the cathode may be transported in forms of both vapor and liquid water through the GDL to a cathode gas channel where it is carried away by the gas stream.

The particular characteristics and structure of the MPL used in the GDL assembly can play a key role in the management of water throughout the fuel cell electrode. Conventionally, MPL materials consist mainly of carbon powder and PTFE particles. By designing the material and structural configuration of the MPL, enhancements to overall water management within the fuel cell system may be achieved. MPLs disclosed herein have the ability to effectively address the detrimental water accumulation and ice formation. New varieties of CLs that are now emerging in the art, such as thin-film type CLs, have the potential to increase fuel cell durability while decreasing cost. Despite these benefits, many of these CLs, including thin-film type, are prone to flooding as a result of limited water/ice storage in the membrane electrode assembly. The disclosed MPL structures can provide water and ice management enhancements to help harness the potential of these new types of catalyst layers.

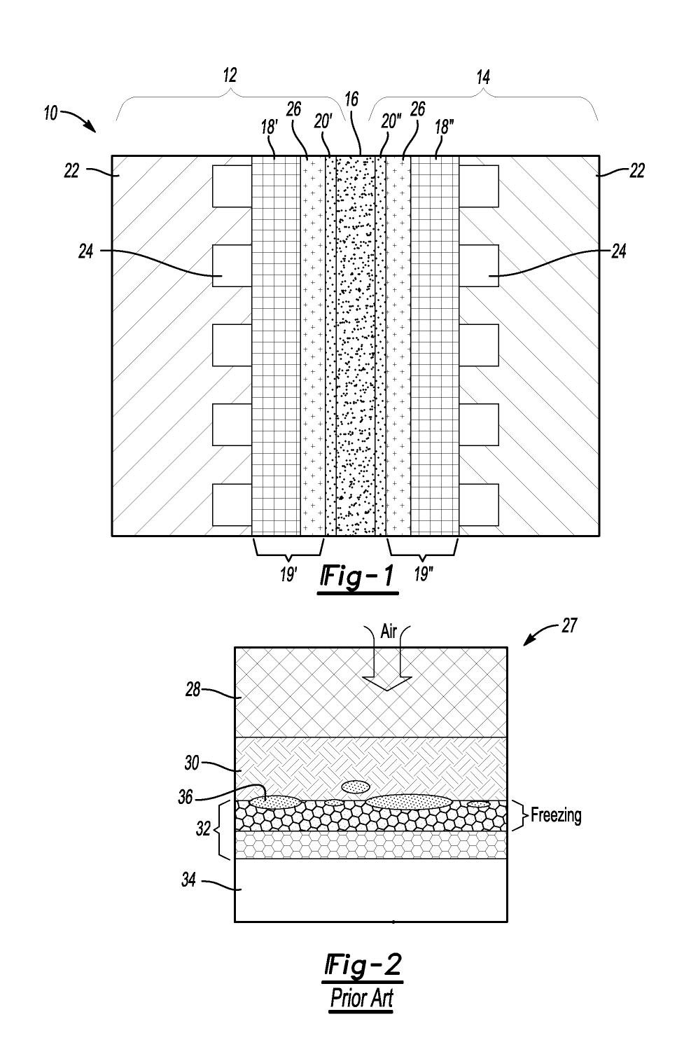

Referring to FIG. 2, a conventional prior art PEMFC 27 is shown. The PEMFC includes a GDBL 28, an MPL 30, a CL 32 and a PEM 34. Conventional PEMFC, such as the one shown in FIG. 2, may not perform at a satisfactory level under subfreezing conditions. During initial startup of the PEMFC, the product water (water produced by the electrochemical reaction) is first absorbed by the PEM 34 in what is known as the PEM rehydration period. After the membrane 34 is fully rehydrated, the product water redistributes in the CL 32.

Conventional MPLs are hydrophobic and have very small pores sizes (i.e. 0.05-0.2 microns). This causes poor liquid water transport through the MPL 30. Thus, much of the liquid water will be absorbed by the PEM or accumulate in the CL 32. If the temperature of the CL 32 is subfreezing, then water in the CL 32 will freeze forming ice 36. The ice 36 may be formed within the CL pores or may be formed at the interface between the CL 32 and the MPL 30. The ice 36 at least partially blocks the oxygen from diffusing into the CL 32 in the PEM 34. This retards the electrochemical reaction and reduces output power of the fuel cell.

The cathode ice storage capacity may be calculated using the equation 2.

Equation 2:

W_{cap}=W_{cap,cl}+W_{cap,m} (2)

where
W_{cap,cl}=δ_{CL}ερ_{ice}+δ_{CL}εₘC_{f,dry}Δλ_{av,CL}M_{H2O}
W_{cap,m}=δₘC_{f,dry}Δλ_{av,m}M_{H2O}
and where
W_{cap} is the ice storage capacity;
W_{cap,CL} is the ice storage capacity offered by the catalyst layer;
W_{cap,m} is the ice storage capacity provided by the polymer electrolyte membrane.
δ_{CL} a is the thickness of the catalyst layer;
ε is the porosity of the catalyst layer;
ρ_{ice} is the density of ice;
εₘ is the volume fraction of ionomer in catalyst layer;
C_{f,dry} is the charge (—SO₃⁻) concentration in dry membrane;
Δλ_{av,CL} is the water uptake by catalyst layer ionomer during freeze startup;
M_{H2O} is the molecular weight of water (18 grams/mole);
δₘ is the thickness of the polymer electrolyte membrane; and
Δλ_{av,m} is the water uptake by the polymer electrolyte membrane during freeze startup.

For example, consider a fuel cell which has an 18 micron thick membrane (conditioned to an initial residual water λ₀=6 and can absorb water until λ=14) and a 10 micron thick CL that has porosity of 0.33. The ice storage capacity of this fuel cell, calculated by Equation 2, is about 0.83 mg/cm². A fuel cell operating at a current density of 0.1 amp/square centimeter (A/cm²) will exceed the ice storage capacity of the fuel cell in approximately 90 seconds. For successful startup in freezing conditions, the fuel cell has to increase its temperature to above zero in less than 90 seconds. This short time-window is challenging for fuel cell startup in freezing conditions, especially from temperatures lower than −20° C. MPLs can be engineered to increase liquid water transport out of the CL and to store ice in the MPL. This reduces the likelihood of flooding and failed start up in freezing temperatures.

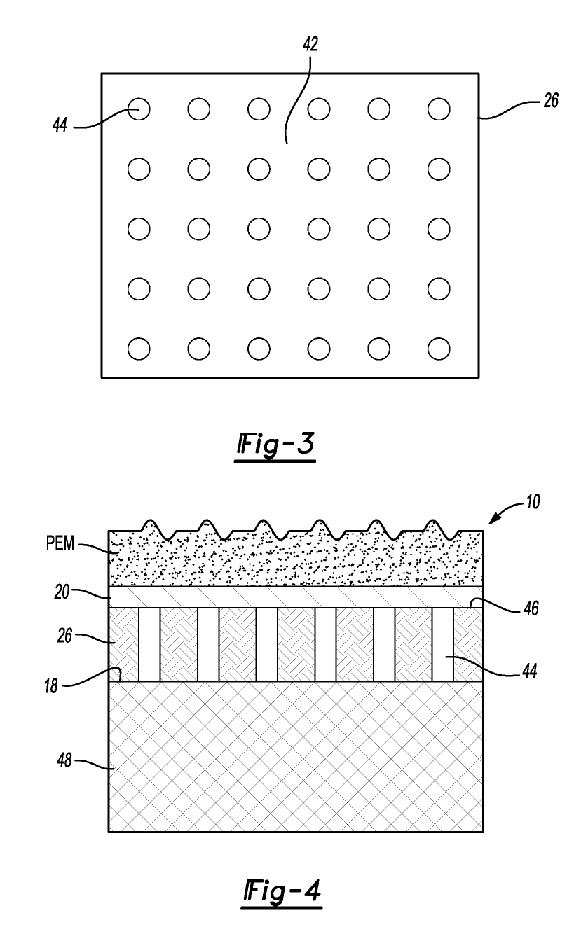

Referring to FIG. 3, the MPL 26 is shown removed from the PEMFC 10. The MPL 26 may have a thickness ranging from 5 to 75 micrometers (μm). The MPL 26 includes a plurality of pores 42. The pores 42 may have a pore diameter of 0.02 to 0.5 μm. The pores 42 may be either hydrophilic or hydrophobic depending upon application. Alternatively, the pores 42 may be mix of hydrophilic and hydrophobic pores. The MPL 26 also includes a plurality of domains 44. The present disclosure contemplates a multitude of different domain 44 arrangements. For example, the domains 44 may be arranged in a specific array or may be chaotically arranged. The domains 44 may have a spacing of 0.1 to 2 millimeters (mm). In one embodiment, the domains 44 are boreholes formed into the MPL 26. The boreholes 44 may have a diameter of 0.5 to 200 μm. Due to their relatively large size the boreholes 44 may be either hydrophilic or hydrophobic. In another embodiment, the domains 44 are a hydrophilic material embedded in the MPL 26.

FIG. 4 illustrates a cross-section view of a portion of the PEMFC 10. The MPL 26 is sandwiched between the catalyst layer 20 and the GDBL 18. The MPL 26 has a first surface 46 and a second surface 48. The first surface 46 is disposed against the CL 20 and the second surface 48 is disposed against the GDBL 18. The domains 44 extend between the first surface 46 and the second surface 48 providing an aperture completely through the MPL 26. Alternatively, the domains 44 may only extend through a portion of the MPL 26. In one embodiment, the domains 44 are boreholes formed into the MPL 26. The Bores 44 may be formed in any suitable manner, for example by laser perforation. Alternatively, the bores 44 may be mechanically formed by drilling or other process. The Bores 44 may be cylindrical or substantially cylindrical. Other shapes and cross-sections are also contemplated. A combination of different shaped bores may also be used.

The domains 44 increase the ice storage capacity. For example, a 30 micron thick MPL having domains of 100 microns in diameter and a domain spacing of 0.5 mm arranged in a square lattice pattern, can store 0.1 mg/cm² of ice. This increases the total ice storage capacity to 0.93 mg/cm², compared to 0.83 mg/cm² in the conventional MPL. This is roughly a 12% increase in ice storage capacity. The domains 44 also increase transportation of super-cooled liquid water out of the CL and into the gas stream. This is due to the significantly reduced water breakthrough pressure and liquid transport resistance. This increases ice storage significantly and enables successful PEMFC startup in freezing temperatures.

In another embodiment, the domains 44 are packets of hydrophilic material embedded into the MPL 26. The hydrophilic material may be hydrophilically treated carbon, hydrophilic polymers (e.g., polyvinyl alcohol (PVA) and ionomer), and metal oxides (e.g., SiO2). The hydrophilic material may wick water and/or ice into the domain 44 further increasing the efficiencies of the domain 44 to capture water and ice. The hydrophilic material packets may be formed by any suitable method. For example, boreholes may be formed into the MPL in a first step. Then in a second step, the boreholes are filled in with a hydrophilic material.

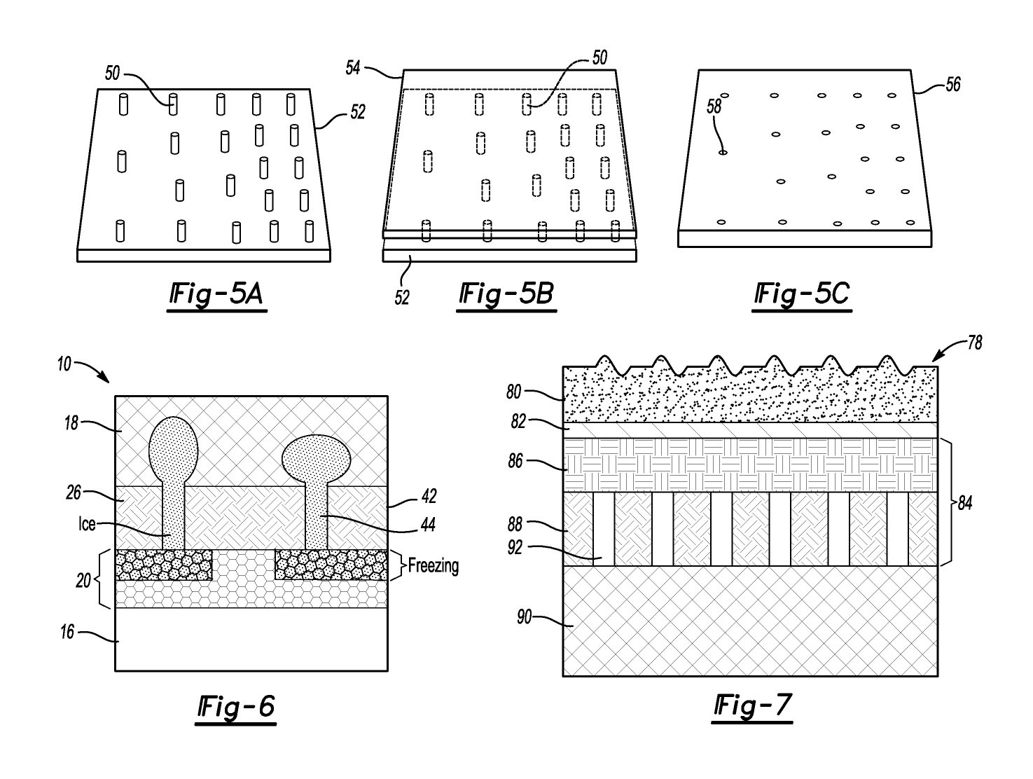

Referring to FIGS. 5A to 5C, an alternative method of fabricating the domains in the MPL is shown. In this alternative, the domains are formed first and the remaining MPL is subsequently formed around the domains.

Referring to FIG. 5A, a plurality of micro-spikes 50 are arranged on a substrate 52. The micro-spikes 50 are arranged on the substrate according to the desired domain pattern. The micro-spikes 50 may be formed by ink jet printing the selected domain material onto the substrate 52.

Next, the remaining MPL is formed onto the substrate 52 as shown in FIG. 5B. The remaining MPL may be formed by depositing carbon ink 54 onto the substrate 52 around the domains 50. The carbon ink 54 is then dried and sintered forming the MPL.

Next, the MPL 56 is removed from the substrate as is shown in FIG. 5C. The micro-spikes 50 may be designed to detach from the substrate 52 when the MPL 56 is removed from the substrate 52. Thus, the micro-spikes 50 remain embedded in the MPL 56 forming packets of material within the MPL 56. The embedded micro spikes 50 form the domains 58 in the MPL 56. The embedded micro spikes 50 may be comprised of a hydrophilic material to provide a hydrophilic domain 58 in MPL 56. Examples of hydrophilic materials include hydrophilically treated carbon, hydrophilic polymers (i.e., polyvinyl alcohol), metal oxides (i.e., SiO₂) and water semi-permeable materials.

Alternatively, the micro-spikes 50 are formed of certain pore former materials. An example material of the pore former is ammonium chloride (NH₄Cl), which decomposes to leave holes in MPL when sintering the MPL at temperatures above 338° C. Thus, the removed MPL 56 has a plurality of boreholes 58 corresponding to the locations of the micro spikes 50.

Referring to FIG. 6, a cross-section of a PEMFC 10 is shown during freezing condition operation. An MPL 26 is disposed between a GDBL 18 and a CL 20. A PEM 16 is disposed adjacent to the CL 20. The MPL 26 includes a plurality of domains 44 and a plurality of pores 42 as previously described. The domains 44 are substantially larger than the pores 42 and are designed to be the main water transport conduit within the MPL 26. The domains 44 perform a majority of the water mass transport leaving the smaller pore 42 less obstructed for better oxygen diffusion. During freezing conditions the domains 44 are also designed to absorb and store ice. By storing the ice in specific domains the ice becomes concentrated in specific areas. This helps to provide ice free zones. As can be seen in FIG. 6, ice forms in the CL 20 and in the GDBL 18 proximate to the domains 44 leaving vast areas of the GDBL 18 and the CL 20 without ice. Thus, oxygen is free to diffuse through the areas without ice providing better cell operation during subfreezing conditions.

Referring to FIG. 7, a cross-section view of a portion of a PEMFC 78 is shown. The PEMFC 78 includes a MPL 84 disposed between the CL 82 and a GDBL 90. A PEM 80 is disposed adjacent to the CL 82. The MPL 84 is comprised of multiple layers. The multiple layers may have different properties, such as one layer being hydrophobic and another layer being hydrophilic. The multiple layers may also have different arrangements of pores and domains. In one embodiment, the MPL 84 includes a first layer 86 and a second layer 88. The first layer 86 is disposed adjacent to the CL 82 and the second layer 88 is disposed against the GDBL 90. The CL 82 has a relatively low water storage capacity. The first layer 86 may be hydrophilic to help wick water (liquid and/or solid) away from the CL 82 to reduce flooding of the CL 82. A hydrophilic first layer may also provide better transport of water from the CL 82 to the second layer 88. The second layer 88 may include a plurality of domains 92. The domains 92 may be boreholes or material packets as previously described. The domains 92 store and transport water from the first layer 86 to the GDBL 90. The second layer 88 may be hydrophobic to direct water into the domains.

In another embodiment, the first layer is hydrophobic and the second layer 88 is hydrophilic. One or both of the first and second layers 86, 88 may contain domains 92. In yet another embodiment, the first and second layers 86, 88 have similar water properties (meaning both are either hydrophobic or hydrophilic). One or both of the first and second layers 86, 88 may contain domains 92.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A fuel cell comprising:
a cathode including a first gas diffusion layer and a first catalyst layer;
an anode including a second gas diffusion layer and a second catalyst layer;
a proton exchange membrane (PEM) disposed between the cathode and anode; and
a microporous layer disposed between the first gas diffusion layer and the first catalyst layer, the microporous layer defining a plurality of bores extending between opposite surfaces of the microporous layer and arranged to concentrate ice formation, under freezing conditions, within the bores to reduce an amount of frozen water within the catalyst layer.

2. The fuel cell of claim 1 wherein the bores have a diameter of 0.5 to 200 μm.

3. The fuel cell of claim 1 wherein the microporous layer is comprised of carbon allotropes and binder.

4. The fuel cell of claim 1 wherein the microporous layer further comprises a first layer disposed against the first catalyst layer and a second layer disposed between the first layer and the first gas diffusion layer and wherein the plurality of bores are only defined in the second layer.

5. The fuel cell of claim 4 wherein the first layer is hydrophilic and the second layer is hydrophobic.

6. The fuel cell of claim 1 further comprising a hydrophilic material disposed within each of the bores.

7. A fuel cell microporous layer disposed between a catalyst layer and a gas diffusion backing layer on a cathode side of the fuel cell, the microporous layer comprising:
a bulk material;
a plurality of pores defined in the bulk material; and
a plurality of domains defined in the bulk material and configured to concentrate ice formation, under freezing conditions, within the domains to reduce an amount of frozen interface between the bulk material and the catalyst layer.

8. The fuel cell microporous layer of claim 7 wherein the domains are bore holes.

9. The fuel cell microporous layer of claim 8 wherein the bore holes have a diameter of 0.5 to 200 μm.

10. The fuel cell of claim 7 wherein the domains extend between opposite surfaces of the bulk material.

11. The fuel cell microporous layer of claim 7 wherein the domains are packets of hydrophilic material embedded in the bulk material.

12. The fuel cell microporous layer of claim 11 wherein the hydrophilic material is one of carbon, polymers and metal oxides.

13. The fuel cell microporous layer of claim 7 wherein the plurality of pores have a diameter of 0.05 to 0.2 μm.

14. The fuel cell microporous layer of claim 7 wherein the plurality of pores are hydrophobic.

15. A cathode microporous layer for a fuel cell comprising:
a first carbon-based material layer adjacent to a catalyst layer; and
a second carbon-based material layer disposed between the first layer and a gas diffusion backing layer, wherein the second layer includes a plurality of domains configured to concentrate ice formation, under freezing conditions, within the domains to reduce an amount of frozen water within the catalyst layer.

16. The cathode microporous layer of claim 15 wherein the first carbon-based material layer is hydrophilic.

17. The cathode microporous layer of claim 15 wherein the first carbon-based material layer is hydrophobic.

18. The cathode microporous layer of claim 16 wherein the second carbon-based material layer is hydrophobic.

19. The cathode microporous layer of claim 15 wherein the plurality of domains are bore holes defined in the second layer.

20. The cathode microporous layer of claim 15 where the plurality of domains are hydrophilic material embedded in the second layer.
